(19) United States
(12) Patent Application Publication
(10) Pub. No.: US 2004/0208199 A1
(43) Pub. Date: Oct. 21, 2004

(54) Data encoding for simultaneous bus access

(76) Inventor: Bo Li, Plano, TX (US)

Correspondence Address: WOMBLE CARLYLE SANDRIDGE & RICE, PLLC, P.O. BOX 7037, ATLANTA, GA, 30357-0037, US

(21) Appl. No.: 10/414,163

(22) Filed: Apr. 16, 2003

(51) Int. Cl. H04J 3/24

(52) U.S. Cl. 370/474

(57) ABSTRACT

A data encoder transmitting data over a media having multiple channels. The data includes an address and a data payload. The data encoder includes a buffer that divides the data payload into a plurality of data segments and forms a plurality of initial states. Each initial state comprises the address and one of the data segments. A first initial state is loaded into a Pseudo Random (PN) generator, and an output codeword from the PN generator is scrambled. A plurality of output signals is generated from the scrambled output and each output signal of the plurality of output signals is transmitted on a corresponding one of the plurality of channels.

### FIELD OF THE INVENTION

The present invention is directed to a digital data communication. More particularly, the present invention is directed to encoding data for transmission on an analog shared bus or over multiple channels.

### BACKGROUND INFORMATION

Digital data may be transmitted over many types of media, such as over wires on a computer bus, wirelessly over air, optically over a fiber optic cable, etc. Most of the media includes multiple “channels” that each carry one bit of data at a time. For example, a computer bus includes a collection of wires, and each wire may be considered a channel that carries a single bit of data during a specific time frame.

Most digital data transmission media allows a single device to access one channel at a time. For example, with an Ethernet bus, typically only a single computer or device may send data over the bus at one time (i.e., during a single time frame). If multiple devices attempt to send data at the same time over the bus, the data on each channel of the bus may be unreadable because the multiple transmitted data bits on a single wire would interfere with each other.

The limitation of a single device transmitting data at a time limits the capacity of a transmission media. It would be beneficial to have a method and apparatus that allows multiple devices to transmit data simultaneously over the same analog shared bus or an equivalent multiple channels at the same time, while being aware of the position of the bits in the assigning channels.

### BRIEF DESCRIPTION OF THE DRAWINGS

FIG. 1 is a block diagram of an encoder and decoder in accordance with one embodiment of the present invention.

FIG. 2 is a block diagram of an encoder/decoder in which the decoder has multiple parallel decoding units.

FIG. 3 is a block diagram of multiple Ethernet switches in accordance with one embodiment of the present invention.

FIG. 4 is a block diagram of a wireless system having an encoder/decoder in accordance with one embodiment of the present invention.

FIG. 5 is a block diagram of an inter-network exchanger in accordance with one embodiment of the present invention.

FIG. 6 is a block diagram of a data storage device in accordance with one embodiment of the present invention.

FIG. 7 is a block diagram of one embodiment of the present invention that is for a typical application of a computer bus.

### DETAILED DESCRIPTION

One embodiment of the present invention is an encoder, and a corresponding decoder, that encodes and decodes digital data so that multiple devices using the encoder can place their data on channels or on an any type of analog shared bus at the same time.

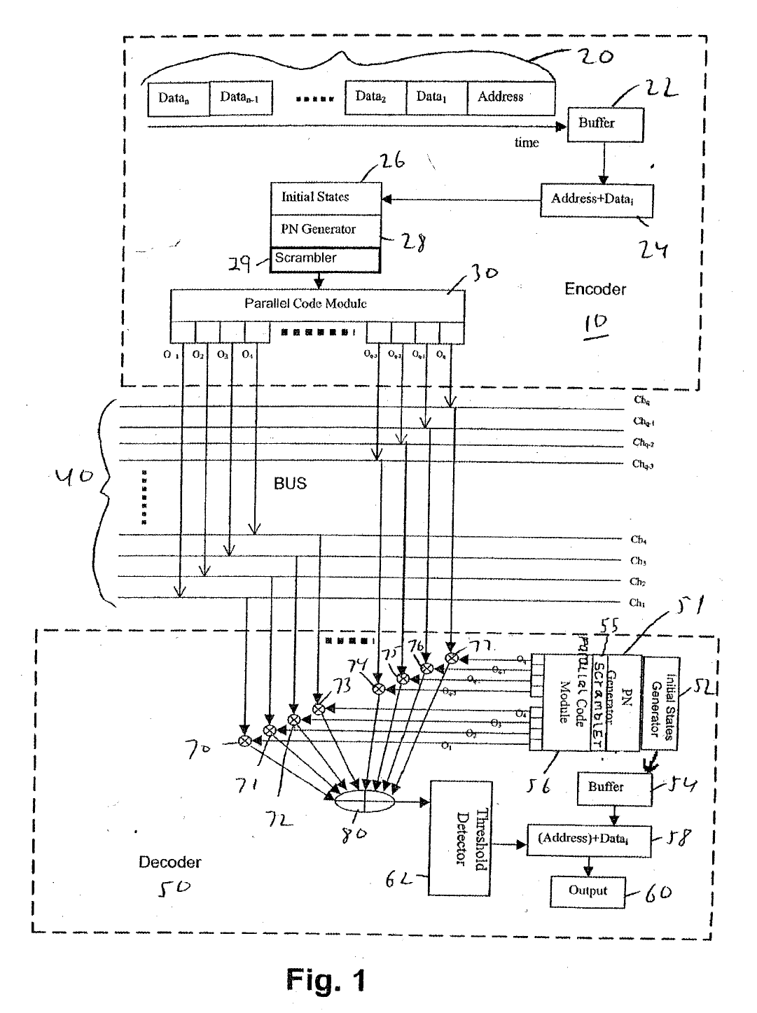

FIG. 1 is a block diagram of an encoder 10 and decoder 50 in accordance with one embodiment of the present invention. Encoder 10 is coupled to an analog shared bus 40 that includes multiple wires or channels Ch₁-CH_{q}. Encoder 10 encodes a digital data packet 20 that includes a destination address (“Address”) and a data payload that is divided into multiple data segments (“Data₁-Dataₙ”).

In one embodiment, the address of digital data packet 20 includes k binary bits that are denoted by {a₁, a₂, a₃, . . . , aₖ}, and includes payload data denoted by {data} which is chopped into a number of data block segments denoted by {dataⱼ}, {data₂}, {data₃}, . . . , {dataₙ}, {dataₙ}, and each bit in a data block segment {dataⱼ} is denoted by {d¹ⱼ, d²ⱼ, d³ⱼ, . . . , d^{p(j)}ⱼ}, where j=1, 2, 3, . . . , n, p(j) is the number of bits in a data block segment {dataⱼ}, and p=max[p(1), p(2) . . . , p(n)].

Encoder 10 includes a buffer 22 that receives data packet 20 and groups it into a data block containing {Address}+{Dataᵢ}, where i=1, 2, 3, . . . , n (box 24). Each of these blocks to be spread fills into or partially fills into an initial state 26 of a Pseudo Random (“PN”) generator 28 having m stages, and each of the bits is loaded into a respective stage. Each set of bits that form an initial state is denoted as {g₁, g₂, g₃, . . . , gₘ}, m>k+p. In one embodiment, m−k−p=s>0, the residues of the initial state can be filled by a number of bits with arbitrary selected value, denoted as {r₁, r₂, r₃, . . . , rₛ}. In this embodiment, initial state 26 loaded into PN generator 28 is the combination of the address, one of the data segments, and residues, {g₁, g₂, g₃, . . . , gₘ}={a₁, a₂, a₃, . . . , aₖ}+{d¹ⱼ, d²ⱼ, d³ⱼ, . . . , d^{p(j)}ⱼ}+{r₁, r₂, r₃, . . . , rₛ}, where s=m−k−p. In another embodiment, n=m, s=0, and there are no residues.

PN generator 28 generates a block of PN code for each set of initial state bits loaded into it. The block of PN code is received by a parallel code module 30. In one embodiment, PN generator 28 is an M-sequence PN generator. An M-sequence PN generator is a known PN generator that generates an m-bits state PN code sequence with a period of 2^{m}−1. In other embodiments, PN generator 28 can be any type of PN generator. Other embodiments may substitute PN generator 28 with any device that generates a random-like code or noise-like code if it has similar property as PN code of rich code space and orthogonal (i.e., low cross-correlation).

In an embodiment where PN generator 28 is an M-sequence PN generator, the m-bits codeword loaded to the initial state of PN generator 26 is spread into a “q” bits codeword a partial block of full period 2^{m}−1 of PN code. The size of the “q” bits block is selected to match the number of “channels” in the analog shared bus or multiple channels in transmission media 40 shown In FIG. 1.

In one embodiment, a scrambler 29 scrambles the “q” bits codeword generated from PN generator 28 into a “q” bits scrambled codeword. In one embodiment, scrambler 29 is a Gold code generator. In another embodiment, scrambler 29 is a Kasami code generator.

In one embodiment, the “q” bits scrambled codeword received by parallel code module 30 is received as binary bits (i.e., “1”s and “0”s). Parallel code module 30 converts each bit into an analog representation of “+1” and “−1” volts. For example, each “1” bit may be converted into +1 volt, and each “0” bit may be converted into −1 volt. In another example, each “1” bit may be converted into +5 volts, and each “0” bit may be converted into −5 volts. The conversion parameters can be based on the type of transmission media.

The output of parallel code module 30 is buffered and in one embodiment is greater than the number of initial states in order to overcome the interference from others. The output of parallel code module 30 is denoted by {o₁, o₂, o₃, . . . , o_{q}}, where q>m>k+p. In one embodiment, the buffered data is simultaneously and in parallel placed on the analog shared bus 40 which has q different channels. The data is followed by the next combination of {address}+{dataᵢ} processed by PN generator 28, and so on, until the last data segment (dataₙ) is transmitted. In another embodiment, the buffered data is not placed in the analog shared bus 40 simultaneously. In this embodiment, it requires some respective changes in the decoder.

The address of data packet 20 may represent an Internet Protocol (“IP”) address or other address that corresponds to destination information. For example the address may be a 32-bit IP address in the IPv4 standard, a 128-bit IP address in the IPv6 standard, a 48-bit Media Access Control (“MAC”) address, a telephone number, etc. Further, in a high density multiple layers data storage implementation, the address can represent a layer order and the location in the layer of the codeword. In a computer analog shared bus implementation, the address can represent a component or driver that is attached to the computer analog shared bus. In a switch implementation, it can represent the port in the switch and the end user in the network. In an inter-network implementation, it can represent the network identification, and the partition identification for the network. In other embodiments, the address can also be the combination of above such as the IP address plus the network identification. The payload data of data packet 20 may include any data needed to be delivered, including a source address.

A decoder 50 decodes the desired data block segments from the analog shared bus 40. Decoder 50 includes an initial states generator 52 that generates all combinations of initial states that could be comprised by initial state 26. In one embodiment, initial states generator 52 is aware of the value of the address portion of the initial state {a₁, a₂, a₃, . . . , aₖ}, and therefore only needs to generate all combinations of the data portion, {d¹ⱼ, d²ⱼ, d³ⱼ, . . . , d^{p(j)}ⱼ} and the residue portion, {r₁, r₂, r₃, . . . , rₛ}. In another embodiment, the initial states generator is aware of the residue portion. For each value of initial states generated, a PN generator 51, a scrambler 55, and a parallel code module 56 generates PN code, scramble code, and +1 and −1 voltage levels respectively. In one embodiment, PN generator 51, scrambler 55, and parallel code module 56 are identical to PN generator 28, scrambler 29, and parallel code module 30 of encoder 10.

Each output of parallel code module 56, {o′₁, o′₂, o′₃, . . . , o′_{q}}, is coupled to a respective multiplier 70-77, which is also coupled to the respective channel of analog shared bus 40. Multipliers 70-77 multiply each {o₁, o₂, o₃, . . . , o_{q}} by each {o′₁, o′₂, o′₃, . . . , o′_{q}} which is {o_{1*}o′₁, o′_{2*}o′₂, o′_{3*}o′₃, . . . , o_{q*}o′_{q}}. Because each output is a + or − value, if a matched pair of o_{q} and o′_{q} is multiplied together, the result will be a positive number, whereas if the pair does not match, the result will be a positive or negative number with likely equal opportunity.

The outputs of multipliers 70-77 are added together by an adder 80. When the outputs of parallel code modules 30 and 56 match, adder 80 will generate a large positive number. When the outputs of parallel code modules 30 and 56 do not match, adder 80 will likely generate a value approaching zero, since the plus and the minus values output from multipliers 70-77 tend to cancel each other out.

In an embodiment in which the buffered data from parallel code module 30 is placed on analog shared bus 40 is in time order not simultaneously, the buffered data in parallel code module 56 in decoder 50 placed on the analog shared bus 40 must follow the same time order. A different delay is introduced to the different channel before adder 80 to make the product o_{1*}o′₁, o_{2*}o′₂, o_{3*}o′₃, . . . , o_{q*}o′_{q} arrive at adder 80 simultaneously.

The output of adder 80 is input to a threshold detector 62, which identifies when the output value exceeds a predetermined number, thus indicating that the outputs of parallel code modules 30 and 56 match.

Each set of outputs of initial states generator 52 is stored in a buffer 54. When threshold detector 62 detects a match, the set of initial states that generated the match is stored as an {address}+{dataᵢ} at box 58. After all of the data segments are identified, the output data packet, with address and data segments, is placed in output 60.

In one embodiment, decoder 50, which acts as a matched filter, has a substantially higher clock rate than encoder 10, since it must run through all possible values of initial states to process each set of data. In one embodiment, where analog shared bus 40 is a 64-bit analog shared bus the number of bits to be spread is loaded in the initial state of PN generator 28, among them there are 8 bits data to be decoded by the decoder as it is aware of the address part. The clock speed at decoder 50 is 2⁸, or 256 times the clock speed of encoder 10.

The embodiment shown in FIG. 1 has a single encoder and corresponding decoder. However, other embodiments allow multiple encoders to simultaneously access analog shared bus 40. The data encoded from the multiple encoders can share the same analog bus simultaneously. They can be separately decoded with different destination addresses or different residues with the same destination address, because of the low cross-correlation between them.

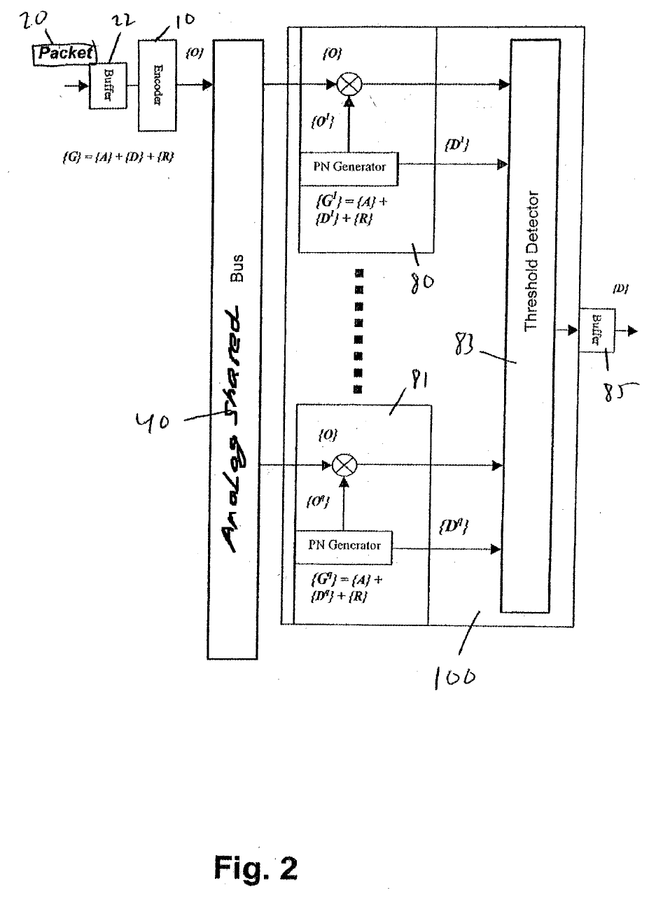

In order to avoid the requirement of decoder 50 to have a substantially higher clock speed than encoder 10, in one embodiment the decoder has multiple units operating in parallel and each unit only handles a part of the possible value of the initial states, so that each unit does not require as high speed clock. FIG. 2 is a block diagram of an encoder/decoder in which the decoder has multiple parallel decoding units. The encoder 10 receives the packet 20 through a buffer 22 (buffer 22 may also be part of encoder 10 as in FIG. 1). Encoder 10 outputs data onto the analog shared bus 40.

For the parallel scheme shown in FIG. 2, the following notation is used:

Address: {A}={a₁, a₂, a₃, . . . , aₖ};

Data block: {D}={d¹ⱼ, d²ⱼ, d³ⱼ, . . . , d^{p(j)}ⱼ}; j=1, 2, . . . , n

Residues: {R}={r₁, r₂, r₃, . . . , rₛ};

Initial states: {G}={g₁, g₂, g₃, . . . , gₘ};

Output from PN generator: {O}={o₁, o₂, o₃, . . . , o_{q}};

Therefore, {G}={A}+{D}+{R}.

Instead of a single decoding unit as in FIG. 1, there are multiple q decoding units 80, 81. Each unit includes initial state generator, PN generator, Scrambler, and parallel code module similar to decoder 50 in FIG. 1. It has its own initial state from {G¹} to {G^{q}} respectively. For example, if there is a p-bits data block to be decoded, to run through all states q=2^{p} states is required. The summation of the product of an output of each decoder unit and the signal in the corresponding channel of analog shared bus 40 passes to a threshold detector 83 along with the data field in the initial state. If the summation exceeds the threshold and passes through threshold detector 83 (e.g., the i^{th} unit passes through), the corresponding data block in the initial state of the PN generator in the i^{th} unit of {Dⁱ} will pass to the output of the decoder into a buffer 85.

In other embodiments, the parallel and serial decoder implementations of FIGS. 1 and 2 can be combined together to provide the maximum possible states of the data field within a given period. In this embodiment, instead of single initial state in each unit in parallel, each unit runs through multiple states. For example, for W states, the first decoder unit runs from {D¹} through {D^{W}} and the last decoder unit runs from {D^{V-W}} to {D^{W}}.

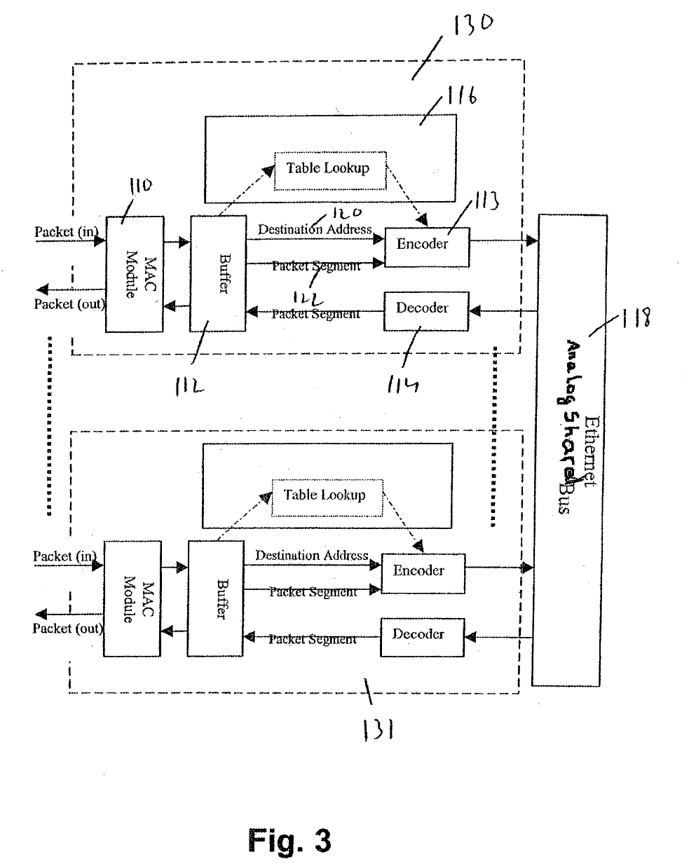

FIG. 3 is a block diagram of multiple Ethernet ports 130, 131 in an Ethernet switch in accordance with one embodiment of the present invention. A standard Ethernet signal is input to a MAC module 110 and then a buffer 112. MAC module 110 splits the signal into two parts, packet destination address 120 and packet data. The packet data is grouped into fixed size packet segments 122. An encoder 113, similar to encoder 10 of FIG. 1, has initial states that consists of the packet segment bits, the packet destination bits, and additional information bits for other considerations such as collision avoidance, etc. that can be included as residue bits.

The network port outputs of encoder 113 are coupled to Ethernet analog shared bus 118 which can be an analog shared bus or multiple channels. The ports are interfaced with the network devices (e.g., computers) through the Ethernet devices.

A decoder 114 at a destination port connecting to the Ethernet channel decodes the packet segment to recover the packet and transmits it out to the network through the Ethernet interface. It only picks up those packets having destinations which belong to its corresponding port. A port can support single or multiple network devices. Each network device must have a unique MAC address in one embodiment which is used as the destination address. After the decoding process, the MAC address and possible residues bits are stripped out from the encoded packet before the packet is sent out to the network.

A table lookup 116 can optionally be added to the Ethernet switch in order to save resources. In one embodiment, a network IP address which has a length less than the length of a MAC address (6 bytes or 48 bits) can be assigned to the network device (e.g., a computer). Lookup table 116 stores the pair of the MAC address and the assigning IP address. If a network device (e.g., a computer) attaches to the network, the system detects which port this new device belongs to. A port that the device belongs to will inform a central device for the lookup table update. The network central device will assign an IP address to this new device and periodically update the lookup table sitting at each port. The encoder uses the IP address as the destination address in the encoding process. To obtain the IP address for a new request, the encoder looks through the lookup table for the entry of the network assigned IP and the MAC address pair. The decoder sitting at a specific port only decodes information for the IP addresses corresponding to devices that belong to the port. Address bits and possible residues bits are stripped from the encoded message before the packet is passed to the network.

In another embodiment, the central device does not need to be informed in the event of a new device. The port is only informed that the new device belongs to. The port decodes the packets from the Ethernet analog shared bus of the network for all of the devices that belongs to itself. Initially, for a communication without the destination IP and MAC address pair stored in the lookup table, the encoder uses the destination MAC address to encode the initial setup message which contains the source IP address information, etc. After the connection builds up, the source and destination ports put the destination IP and MAC address pair in its lookup table in cache memory and use IP addresses instead of MAC addresses to encode the packet. If the number of bits in the Ethernet analog shared bus is limited and can not support the full length of this initial encoded packet with the Mac address, it is unnecessary to fill up the Ethernet analog shared bus with the full encoded packet at one time. The initial setup packet encoded with the MAC address can be broken into a number of blocks which can fit into the Ethernet analog shared bus. When the decoder decodes the bits of the first block of the initial setup packet, it will be triggered to decode the consecutive blocks until the full initial setup packet has been decoded.

In one embodiment, the interconnection between each Ethernet switch is the extended Ethernet analog shared bus, as shown in FIG. 3. In another embodiment, one wavelength in a DWDM fiber optics system can be assigned to one channel in the Ethernet analog shared bus respectively. The baseband signal is up-converted to an optical signal in the fiber optics system. The optical signal from the fiber optics system down-converts to baseband to the channeled bus in the Ethernet switch.

In another embodiment, the baseband signal in each channel in the Ethernet analog shared bus can be assigned to a different time slot in a wavelength in a fiber optics system. The baseband signal in the Ethernet analog shared bus is modulated into an optical signal. One time slot in a fiber optics wavelength represents a single baseband channel in the Ethernet analog shared bus. It allows multiple access as multiple signals can be additive in a time slot. Multiple time slots in fiber optics is required to represent the Ethernet analog shared bus. In one embodiment, the system is acknowledged of the starting time slot corresponding to the first channel in the Ethernet analog shared bus.

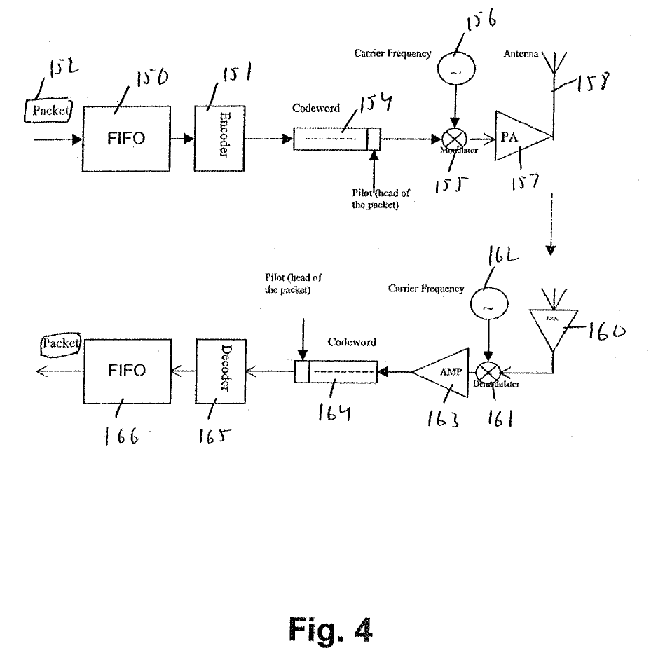

In an embodiment for a wireless application, multiple information bits and destination address are encoded and modulated into RF frequency. The baseband signal is up-converted to the RF signal at the transmitter, and down-converted from the RF signal to the baseband signal at the receiver. FIG. 4 is a block diagram of a wireless system having an encoder/decoder in accordance with one embodiment of the present invention. The input data in the form of a packet 152 is buffered in a first in first out memory (“FIFO”) 150 and chopped into segments which coupled with the destination address as the input to the initial state of an encoder 151. In one embodiment, a pilot is placed in front of the output codeword 154 of the encoder before being modulate in modulator 155 at the carrier frequency 156 into an RF signal (or ultrasound or infrared signals). The pilot signal may only contain the destination address. The RF signal passes to a power amplifier 157 and is sent out to air through an antenna 158.

At the receiver the signal is amplified by a low noise amplifier (“LNA”) 160 and converted down to a baseband signal by a demodulator 161 at the carrier frequency 162 and then amplified by amplifier 163. In one embodiment, a decoder 165 only decodes and searches the pilot which belongs to the objective destination. After decoding the pilot signal, it triggers the full codeword decoding process. These decoded packet segments are buffered to recover the whole packet in a FIFO 166.

Embodiments of the invention can apply to a wireless access system, and wireless internet in which the impact of near-far problem is under control, and broadcast systems such as digital TV which assigns different addresses for different programs to allow a user to select the program by softly changing coding instead of hard-changing frequency. It can be implemented in wireless optical, infrared or ultrasound as well. As there is sufficient address resource in this technology, multiple addresses can be assigned to an end user to support different applications such as to differentiate voice traffic, data traffic etc. In the embodiment of wireless internet, the destination can be either the end user or a port in the wireless internet switch in which it uses wireless media instead of analog share bus in the Ethernet switch architecture. The technique of different sub-addresses to a physical address with different residues can also apply to avoid collision, etc.

In embodiments of the present invention a number of encoded packet data with different destination addresses can share the same multiple channels or analog shared bus. Using an external analog shared bus, multiple network switches or equipment can interconnect with each other. Further, additional networks can connect to each other using a network exchanger to exchange traffic between themselves. A decoder can decode the corresponding packet information. This technique can be used in a network, computer, switch, multilayer data storage system, etc.

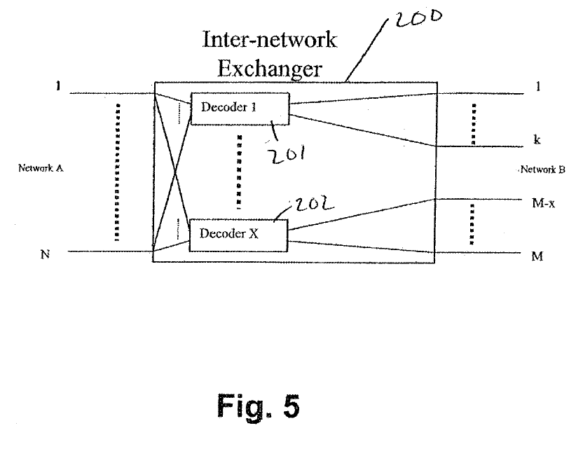

Embodiments of the present invention can be used for inter-networking between different networks. FIG. 5 is a block diagram of an inter-network exchanger 200 in accordance with one embodiment of the present invention. For two networks A and B, there are number of N corresponding channels (or wavelengths in a fiber optics system, etc.) in network A and number of M channels in network B. In network A, to match the number of channels, there are the number of N bits outputs of both an encoder and decoder. Similarly, in network B, to match the number of channels M in network B, there are number of M outputs of a PN generator of both an encoder and decoder.

When a packet is forwarded from network A to network B, exchanger 200 needs to transfer the desired traffic of this packet from the N channels in network A to the M channels in network B. Exchanger 200 includes a number of decoders 201, 202 similar to decoder 50 of FIG. 1. To represent a specific packet or segment of a packet in Network A and B, it requires N bits for N channels in network A and M bits for M channels in network B. Exchanger 200 transforms these N bits of information in network A into M bits in network B with the desired address. The N bits information in N channels in network A are encoded so that they can represent k (k<M or k=M) bits for k channels. Each of these k bits is a partition of M bits in network B if k<M. It takes “x” different partitions to make up (or constitute) all M bits for M channels in network B. If M/k is a integer number, x=M/k, otherwise x=(integer part of M/k)+1. It requires a number of “x” partitions to simultaneously make up the full M bits information in network B if the system loading requirement is met. There are N bits of N channels in network A to represent one of the partition through exchanger.

With an external analog shared bus structure such as described in conjunction with FIG. 3, any network equipment such as a switch can share the information with other equipment. This network structure allows all equipment, such as a network switch, to transmit/receive information at any time and any location within the network without control by a central device.

A packet can be delivered with one or through the chain of multiple networks from the source through to the destination. One network can interact with one or other multiple networks. Each network is assigned a unique network identification. A partition within one network is assigned a partition identification. The data block segment can be encoded with the packet destination address and this network identification and partition information forms a network chain in the routing path. It can transfer from one network to a next desired network indicated by the network identification. The network identification chain contains the network identification information from the starting network where the source belongs to through intermediate networks to the ending network where the destination belongs to.

Communication between two end users may need to go through a number of networks, for example from network A to network B to network C etc. A network may interact with a number of different networks. An exchanger 200 may be included between each pair of networks to perform traffic transformation. These networks can be an Ethernet network, a subnet, a local area network, a metro network, a backbone network, etc.

Exchanger 200 can be described as follows:

{¹a₁, ¹a₂, . . . ¹a_{N}} N bits from network A to represent 1^{st} partition of k bits out of M bits information in network B;

{²a₁, ²a₂, . . . ²a_{N}} N bits from network A to represent 2^{nd} partition of k bits out of M bits information in network B;

.

.

.

{^{X}a₁, ^{X}a₂, . . . ^{X}a_{N}} N bits from network A to represent the last (X^{th}) partition of k bits out of M bits information in network B.

Therefore, a match procedure is used to generate the desired M bits of information from “x” number of partitions in network B which are decoded by “x” number of parallel N bits in network A. For each of these N bits the information contains not only destination of the packet but also the partition block and the network identification that it will forward to. In this embodiment from network A to network B, it is the identification of network B. This network identification and partition information of a destination network is stripped out after the Exchanger forwards the information to this network B.

If there are multiple “sub-addresses” for a physical address, one embodiment can use a number of residue bits in the initial state of the PN generator to differentiate one physical address from the number of sub-addresses to avoid packet collision. Before encoding a data block with a “sub-address” for an address, the encoder scans through the network to detect the occupancy of the “sub-address”. If it is occupied, the encoder will hold the data in the buffer and scan another “sub-address” until at least one “sub-address” is free. The encoder will encode the data blocks for this free “sub-address” for the specific physical address. After a connection has set up, there may be a single or multiple reserved “sub-addresses” assigned to this connection. The reserved “sub-addresses” are for an established connection only. The encoder does not scan through these reserved “sub-addresses” for the data block before a connection has setup.

For example:

{R}={R₁}+{R₂}

{R}={r¹, r², r³, . . . , rₛ}

{R₁}={r¹, r², r³, . . . , rₛ}

{R_{2}}={r^{s1+1}, r^{s1+2}, r^{s1+3}, . . . r^{s}},

where {R₁} is reserved for an established connection, s1>=1. {R₂} is for the initial connecting setup trial.

In one embodiment, a pilot associated with this “sub-address” can be assigned. This pilot only contains “sub-address” information without the packet segment data field. It can be called an Associative Indication or a Pilot. It is simultaneously placed on the analog shared bus with the original encoded data block to indicate the occupancy of this “sub-address”.

For example, in the following data block,

Address: {A}={a¹, a², a³, . . . , a^{k}};

Data block: {D}={d¹ⱼ, d²ⱼ, d³ⱼ, . . . , d^{p(j)}ⱼ} (for j^{th} packet segment of data block);

Residues: {R}={1, r², r³, . . . , r^{s}} (the first bit of one is for a non-pilot);

Initial states of the encoder: {G}={g¹, g², g³, . . . , g^{m}}={A}+{D}+{R}; (the information bits to be spread)

Output from encoder: {O}={o₁, o₂, o₃, . . . , o_{q}}.

The Associative Indication Pilot can be:

Address: {A}={a¹, a², a³, . . . , a^{k}};

Data block: {D′}={0, 0, 0, . . . , 0} (there are number of j zeroes);

Residues: {R′}={0, r², r³, . . . , r^{s}} (the first bit set to zero is reserved for the Associative Indication Pilot);

Initial states of the encoder: {G}={g′¹, g′², g′³, . . . , g′^{m}}={A}+{D′}+{R′};

Output from the encoder: {O}={o′₁, o′₂, o′₃, . . . , o′_{q}}.

For a large scale network having a span that is greater than the information bit duration, the above scheme is still applicable and can reduce collisions for the same physical address. A different embodiment can also be used in which the initial setup connection hops through unreserved “sub-addresses” that can have chance of collision randomly. After a connection setup, it will switch to and occupy a reserved “sub-address”.

Further, for both small (the network scale is smaller than a bit duration) and large scale systems, a set of residues can be assigned to a single connection. It can hop among the residues set during its connection to achieve a better signal to interference level and to provide security assuming both parties (sender and receiver) know the hopping pattern(s).

Various network topologies using the present invention can be used. A uniform structure uses the universal device destination to encode the packet. For example, it uses the MAC address as the destination address for the encoder. Network equipment such as the switch can access this uniform structure network. The switch can have single or multiple ports. The encoder and decoder sit at the port. The encoder encodes information and then forwards it to the decoder which decodes information from the network. Each port can carry single or multiple devices (e.g., a computer).

In another embodiment, a hierarchy structure has multiple layers to allow the network to support a universal destination address and a network assigned IP address. When a party A tries to communicate with party B, without knowledge of the network IP address of party B, it can send out the information through the uniform network using the universal address of party B to encode the message. After communication setups, when both parties acknowledge the identification address of the other party, they can encode the message with these addresses through a second network layer, as the network assigned address usually takes less network resources than the universal address.

Another embodiment for the hierarchy structure is a network that carries a number of sub networks. Inter-network exchanger 200 can perform the information exchange between them. In one embodiment, it can be one physical network with a logical hierarchy structure.

In an embodiment for a fiber optics system, if synchronization across different wavelengths in a DWDM system can be achieved within a fraction of an information bit duration, the encoding/decoding of the present invention can be implemented. When a packet is encoded in baseband, it utilizes each channel in the analog shared bus. The optical signal in each wavelength is modulated by this corresponding baseband signal in each channel respectively. Synchronization is required across those optical channels (i.e., wavelengths) that correspond to the physical baseband signal in the level of a fraction of an information bit. The signal modulation in the optical channel (wavelength) should be additive to allow multiple access so that multiple modulated signals can be additive and share the same wavelength. Therefore, similar to a baseband system, a number of packets can share the number of optical channels simultaneously.

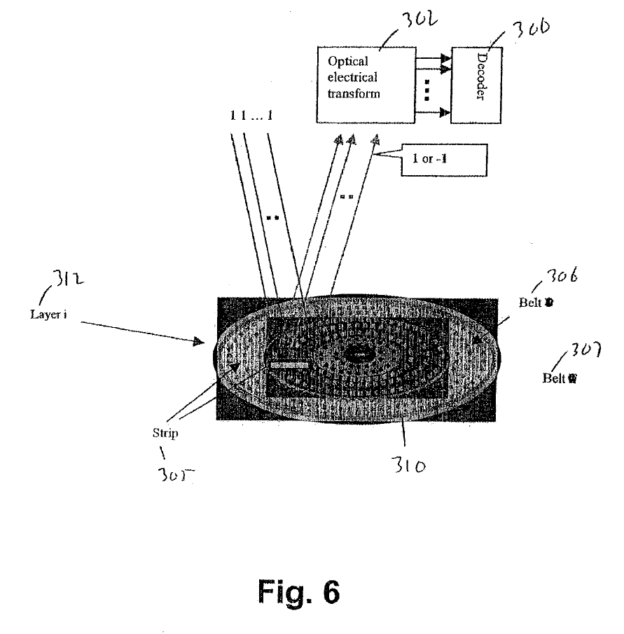

FIG. 6 is a block diagram of a data storage device in accordance with one embodiment of the present invention. Data blocks are stored in a strip 305 or as any other shape in a layer 312 of a multi-layered data storage media 310 by using an encoder according to embodiments of the present invention. Each strip stores a number of bits of information of the storage device. The original data to be stored is buffered and grouped into multiple data segments {d¹ⱼ, d²ⱼ, d³ⱼ, . . . , d^{p}}. A data block stores the data {o₁, o₂, o₃, . . . , o_{q-1}, o_{q}} which is generated by an encoder to represent a complete data block {a¹, a², a³, . . . , a^{k}}+{d¹ⱼ, d²ⱼ, d³ⱼ, . . . , d^{p}}+{r¹, r², r³, . . . , r^{s}}, where {a¹, a², a³, . . . , a^{k}} is the destination data, and {r¹, r², r³, . . . , r^{s}} is the residue data used to fill up the PN generator initial states. In some embodiments, the residues {r¹, r², r³, . . . , r^{s}} can be eliminated for most or all of the data segments. The address part helps to distinguish the encoded data {o₁, o₂, o₃, . . . , o_{q-1}, o_{q}} in different strips from each other and minimizes interference. The data may be placed in parallel in a belt 306, 307 equal distance to the center (axis). There may be a number of belts in one layer, and a number of layers.

In order to retrieve stored data, multiple lasers can focus at the data storing location surface(s) to read a group of data, for example {o₁, o₂, o₃, . . . , o_{q-1}, o_{q}}, or a single laser focuses at a single location and scans through the locations for a group of data, for example {oᵢ|i=1, 2, . . . , q}. A receiver receives a block of the data {o₁, o₂, o₃, . . . , o_{q-1}, o_{q}} which is decoded into the {a¹, a², a³, . . . , a^{k}}+{d¹ⱼ, d²ⱼ, d³ⱼ, . . . , d^{p}}+{r¹, r², r³, . . . , r^{s}} by a decoder 300 after being transformed into an electric signal by an optical to electrical transform 302. Decoder 300 is similar to decoder 50 of FIG. 1. The output of decoder 300 is the data block {a¹, a², a³, . . . , a^{k}} at a desired location defined by {d¹ⱼ, d²ⱼ, d³ⱼ, . . . , d^{p}}. There should be a distance between different layers so that the interference from other layers is within acceptable level. The data storage can be provided two forms, +1 or −1. In one embodiment, using reflection from the top or bottom of a layer, 0 or 180 degrees phase difference for +1 or −1 respectively can be achieved by controlling the thickness of a layer.

As disclosed, embodiments of the present invention allow data to be encoded and decoded so that multiple data can be present simultaneously on an analog shared bus or over other types of media having multiple channels. The encoding technique minimizes or eliminates interference between the data.

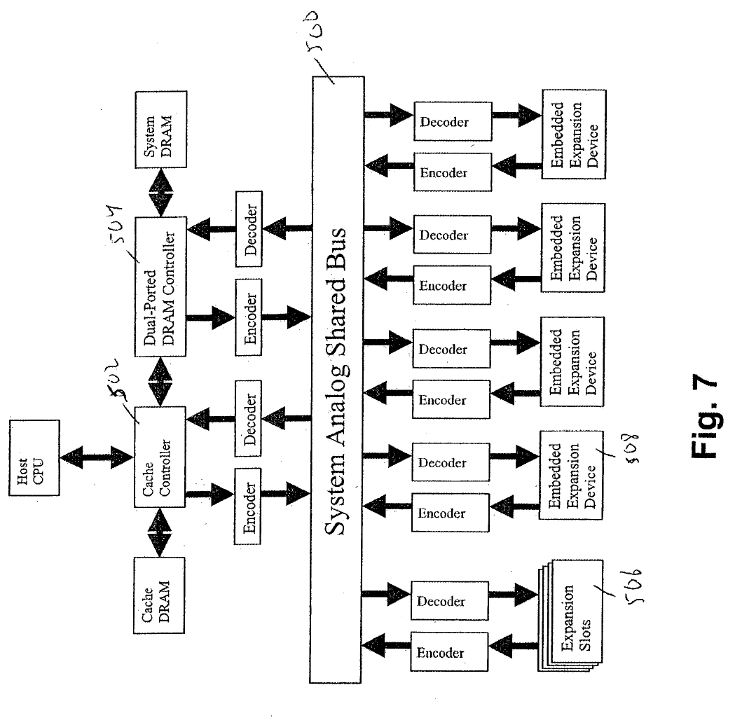

FIG. 7 is a block diagram of one embodiment of the present invention that is for a typical application of a computer bus. All data that is sent to or received from an analog shared computer bus 500 is processed by an encoder or a decoder. The encoder encodes the packet data with the device or component destination address and is forwarded to analog shared bus 500. The present invention allows multiple encoded packets to share analog shared bus simultaneously. The decoder may a dummy device that is not controlled by a centralized device. The decoder only decodes the packet data which belongs to the destination device itself. The component or device can be cache controller 502, a dual-ported DRAM controller 504, expansion slots 506, an embedded expansion device 508, etc. In one embodiment, the encoder does not need to be controlled by a centralized device unless it is used for a special purpose.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of transmitting first data over a media having a plurality of channels, wherein the first data comprises an address and a data payload, the method comprising:
dividing the data payload into a plurality of data segments;
forming a plurality of initial states, wherein each initial state comprises the address and one of the data segments;
loading a first initial state into a Pseudo Random (PN) generator;
scrambling an output codeword from the PN generator;
generating a first plurality of output signals from the scrambled output; and
transmitting each output signal of the first plurality of output signals on a corresponding one of the plurality of channels.

2. The method of claim 1, wherein each initial state further comprises a residue.

3. The method of claim 1, wherein the PN generator is an M-Sequence generator and a scrambler using a Gold code scrambles the output codeword.

4. The method of claim 1, wherein the first initial state comprises a plurality of binary bits, and the PN generator comprises a plurality of stages, wherein loading the first initial state comprises storing one of the bits into a corresponding one of the stages.

5. The method of claim 1, wherein generating the plurality of output signals comprises:
receiving a plurality of output binary bits from the PN generator;
scrambling the output binary bits; and
converting each output bit to a plus or minus voltage level analog signal.

6. The method of claim 5, wherein converting each output bit comprises converting a 1 bit to the plus voltage level, and converting a 0 bit to the minus voltage level.

7. The method of claim 1, comprising loading additional initial states into the PN generator until all of the data segments have been loaded.

8. The method of claim 1, further comprising:
scrambling a second output codeword from a second PN generator;
generating a second plurality of output signals from the scrambled second codeword; and
transmitting each output signal of the second plurality of output signals on the corresponding one of the plurality of channels simultaneously with the transmission of each output signal of the first plurality of output signals.

9. The method of claim 1, further comprising:
generating a plurality of decoding output signals;
multiplying each of the plurality of decoding output signals to a corresponding output signal of the first plurality of output signals received from one of the channels at a plurality of multipliers;
adding together a plurality of outputs of the multipliers at an adder;
determining whether an output of the adder exceeds a threshold; and
generating an output data segment if the threshold is exceeded.

10. The method of claim 1, wherein the address comprises a destination network address and the media is an analog shared bus.

11. The method of claim 10, wherein the destination network address is a Media Access Control address.

12. The method of claim 1, wherein the address comprises an identification of a network and a partition identification of a network.

13. The method of claim 1, wherein the media is a data storage device having layers, and the address comprises a layer.

14. The method of claim 1, wherein the media is an optical fiber and the channels are wavelengths.

15. The method of claim 1, wherein the media is a computer bus and the address comprises an identification of a device coupled to the computer bus.

16. A data encoder for transmitting first data over a media having a plurality of channels, wherein the first data comprises an address and a data payload, the data encoder comprising:
a buffer that divides the data payload into a plurality of data segments;
an initial states module coupled to the buffer that forms a plurality of initial states, wherein each initial state comprises the address and one of the data segments;
a Pseudo Random (PN) generator coupled to the initial states module;
a scrambler coupled to said PN generator; and
a parallel code module coupled to the scrambler, wherein the parallel code module receives a first plurality of output signals from the scrambler and transmits each output signal of the first plurality of output signals on a corresponding one of the plurality of channels.

17. The data encoder of claim 16, wherein each initial state further comprises a residue.

18. The data encoder of claim 16, wherein the PN generator is an M-Sequence generator.

19. The data encoder of claim 16, wherein the first initial state comprises a plurality of binary bits, and the PN generator comprises a plurality of stages that store one of the bits into a corresponding one of the stages.

20. The data encoder of claim 16, wherein the parallel code module receives a plurality of output binary bits from the scrambler and converts each output bit to a plus or minus voltage level analog signal.

21. The data encoder of claim 20, wherein the parallel code module converts a 1 bit to the plus voltage level, and converts a 0 bit to the minus voltage level.

22. The data encoder of claim 16, wherein the address comprises a destination network address and the media is an analog shared bus.

23. The data encoder of claim 22, wherein the destination network address is a Media Access Control address.

24. The data encoder of claim 16, wherein the address comprises an identification of a network.

25. The data encoder of claim 16, wherein the media is a data storage device having layers, and the address comprises a layer.

26. The data encoder of claim 16, wherein the media is an optical fiber and the channels are wavelengths.

27. The data encoder of claim 16, wherein the media is a computer bus and the address comprises an identification of a device coupled to the computer bus.

28. The data encoder of claim 16, wherein the media is air and further comprising an RF modulator coupled to said parallel code module.

29. A network exchanger comprising:
a first input for coupling to a first network having a first network identification and a first partition identification;
a second input for coupling to a second network having a second network identification and a second partition identification;
a buffer that receives data having a destination address from the first network and divides the data into a plurality of data segments;
an initial states module coupled to the buffer that forms a plurality of initial states, wherein each initial state comprises the destination address, the second network identification, the second partition identification, and one of the data segments for the second partition identification;
a Pseudo Random (PN) generator coupled to the initial states module;
a scrambler coupled to said PN generator; and
a first parallel code module coupled to the scrambler, wherein the first parallel code module receives a first plurality of output signals from the scrambler and transmits each output signal of the first plurality of output signals on the second partition of the second network.

30. The network exchanger of claim 29, wherein said first network comprises a first plurality of packet segments that are transmitted on an analog shared bus, and wherein the network exchanger in parallel decodes the plurality of packet segments to derive a plurality of partitions of the second network, wherein the plurality of partitions form a plurality of channels of the second network.

31. The network exchanger of claim 30, wherein a second plurality of packet segments and an address and a residue are decoded for the second network from the first plurality of packet segments.
